(19) United States
(12) Patent Application Publication
(10) Pub. No.: US 2026/0280180 A1
(43) Pub. Date: Sep. 17, 2026

(54) CONNECTOR AND METHOD FOR MANUFACTURING CONNECTOR

(71) Applicant: YOKOWO CO., LTD., Chiyoda-ku, Tokyo (JP)

(72) Inventors: Yoshio TAGAWA, Gunma (JP); Kenta TAKAHASHI, Gunma (JP); Kenta SUGIURA, Gunma (JP)

(73) Assignee: YOKOWO CO., LTD., Chiyoda-ku, Tokyo (JP)

(21) Appl. No.: 18/875,746

(22) PCT Filed: Jun. 16, 2023
(86) PCT No.: PCT/JP2023/022363

§ 371 Date: Dec. 17, 2024

(30) Foreign Application Priority Data
Jun. 27, 2022 (JP) 2022-103066

(51) Int. Cl. H01R 13/52; H01R 12/71; H01R 13/115; H01R 43/00

(52) U.S. Cl. CPC H01R 13/521; H01R 12/716; H01R 13/115; H01R 43/005

(57) ABSTRACT

A connector includes: a housing that has an opening; a terminal that is accommodated in the housing; a lid body configured to close the opening; and a covering material configured to cover, from an outside of the housing, the opening that is closed by the lid body. The terminal penetrates the lid body and the covering material and extends toward an outside of the housing.

### TECHNICAL FIELD

The present invention relates to a connector and a method for manufacturing a connector.

### BACKGROUND ART

Patent Literature 1 below relates to a connector, and discloses a structure in which a terminal is inserted and held in a housing without using insert molding.

### CITATION LIST

### Patent Literature

Patent Literature 1: JP2008-305659A

### SUMMARY OF INVENTION

### Technical Problem

In the structure in which a terminal is inserted and held in a housing without using insert molding, an opening for inserting the terminal into the housing and an opening for exposing the terminal to the outside of the housing for connection with the mating terminal are required, and a space is required for the terminal to move when connecting to the mating terminal. Thus, a large number of spaces are formed around the terminal, making it difficult to ensure the waterproofing property.

An example of the object of the present invention is to provide a connector having a good waterproofing property. Other objects of the present invention will become apparent based on the present description.

### Solution to Problem

An aspect of the present invention provides a connector including:
a housing having an opening;
a terminal accommodated in the housing;
a lid body closing the opening; and
a covering material covering, from an outside of the housing, the opening closed by the lid body,
in which the terminal penetrates the lid body and the covering material and extends toward the outside of the housing.

An aspect of the present invention provides a method for manufacturing a connector, the method including:
inserting a terminal into a housing having a first opening and a second opening through the first opening of the housing, and placing the terminal in a state in which the terminal is exposed to an outside of the housing through the second opening and the terminal protrudes from the first opening;
assembling an elastic body having a bottomed hole to close the first opening, and causing the terminal to break through the bottomed hole; and
filling the first opening that is closed by the elastic body with a covering material to cover the first opening from the outside of the housing.

According to the above aspects of the present invention, it is possible to provide a connector having a good waterproofing property.

### BRIEF DESCRIPTION OF DRAWINGS

FIG. 1 is a perspective view of a connector 1 according to an embodiment of the present invention, as viewed from the upper front right side.

FIG. 2 is a perspective view of the connector 1 as viewed from the lower rear right side.

FIG. 3 is a perspective view of the connector 1 as viewed from the lower front right side, in which a sealing material 70 is omitted.

FIG. 4 is a front view of the connector 1.

FIG. 5 is a right side view of the connector 1.

FIG. 6 is a cross-sectional view taken along a line VI-VI in FIG. 4, and shows a board 90 on which the connector 1 is to be mounted by a virtual line.

FIG. 7 is a cross-sectional view taken along a line VII-VII in FIG. 5, in which a lid body 50 and the sealing material 70 are omitted.

FIG. 8 is a cross-sectional view taken along a line VIII-VIII in FIG. 5, in which the lid body 50 and the sealing material 70 are omitted.

FIG. 9 is a partially exploded perspective view of the connector 1 in which the sealing material 70 is omitted, as viewed from the lower rear left side.

FIG. 10 is a partially exploded perspective view of the connector 1 in which the sealing material 70 is omitted, as viewed from the upper rear right side.

FIG. 11 is a cross-sectional view showing a state immediately before a terminal 30 penetrates a bottom portion 62 of a bottomed hole 61 of the lid body 50 during the assembly process of the connector 1.

FIG. 12 is a cross-sectional view showing a state after the terminal 30 penetrates the bottom portion 62 of the bottomed hole 61 of the lid body 50 from the state shown in FIG. 11.

FIG. 13 is a cross-sectional view showing an example in which the bottomed hole 61 in FIG. 11 is replaced with a bottomed hole 161.

### DESCRIPTION OF EMBODIMENTS

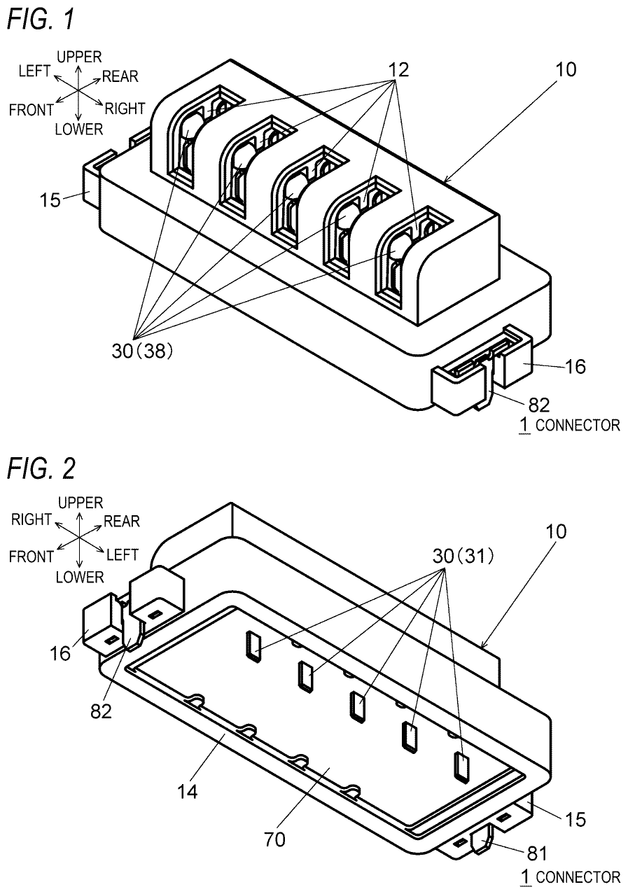

The present embodiment relates to a connector 1 used for electrical connection. FIG. 1 defines the front-rear direction, the upper-lower direction, and the left-right direction of the connector 1 that are orthogonal to one another. The front-rear direction and the left-right direction are parallel to a board 90 (FIG. 6) on which the connector 1 is to be mounted. The upper-lower direction is a direction that is perpendicular to the board 90. The left-right direction is, when a plurality of terminals 30 are provided, the arrangement direction of the terminals 30.

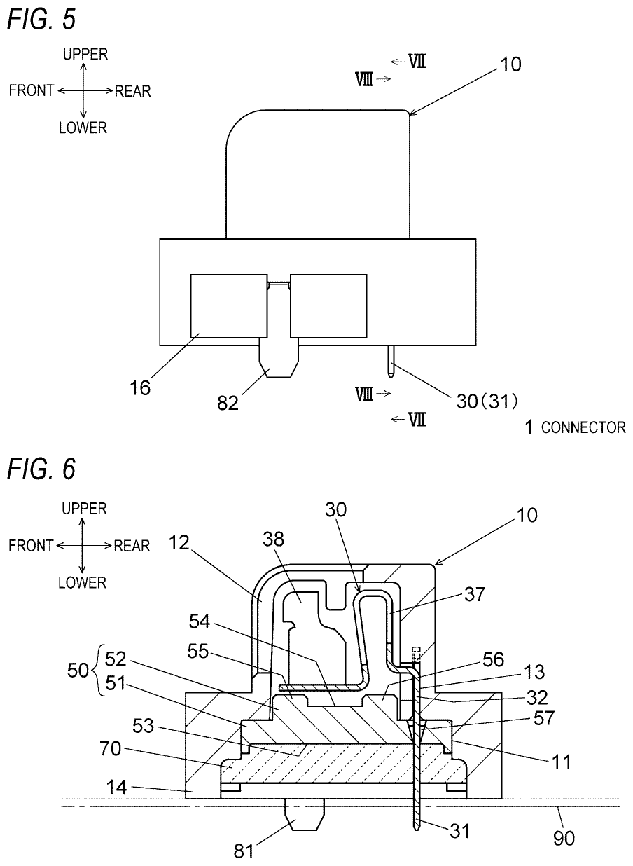

First, the overall structure of the connector 1 will be described with reference to FIGS. 1 to 6. The connector 1 includes an insulating housing 10, the conductive terminal 30, a lid body 50, and a sealing material 70 serving as a covering material. In the present embodiment, five terminals 30 and five lid bodies 50 are provided, but the number of terminals 30 and the number of lid bodies 50 are not limited to five.

The housing 10 is, for example, a resin molded body, and accommodates and holds the five terminals 30. The housing 10 has five first openings 11 that open to insert the terminals 30 into the inside of the housing 10, and five second openings 12 that open to expose the terminals 30 to the outside of the housing 10. The number of first openings 11 and the number of second openings 12 are not limited to five.

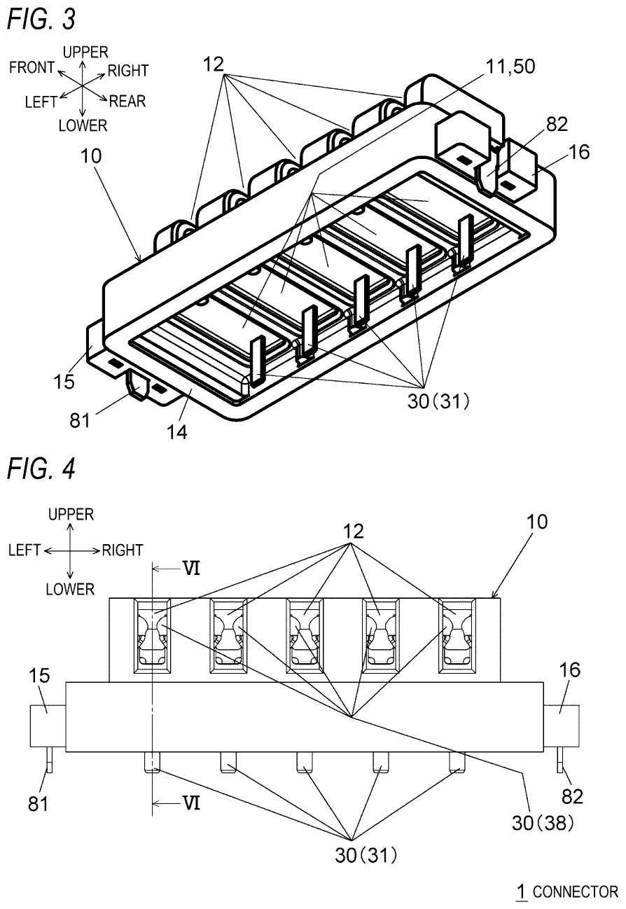

As shown in FIG. 3 and the like, the five first openings 11 are formed in the lower surface of the housing 10 and aligned in the left-right direction. As shown in FIG. 1 and the like, the five second openings 12 are aligned in the left-right direction across the front surface and the upper surface of the housing 10.

As shown in FIGS. 6 to 8, the housing 10 has holding holes 13 for holding held portions 32 of the terminals 30. The holding holes 13 are formed above the rear portions of the first openings 11 and open downward. In the present embodiment, left and right grooves 13a are formed above the holding holes 13.

As shown in FIG. 2 and the like, the housing 10 includes a surrounding portion 14. The surrounding portion 14 is a convex portion that is located at the outer peripheral portion of the lower end of the housing 10 and that extends in a substantially rectangular shape, and protrudes downward so as to surround the front, rear, left, and right of the lower end portions of the five first openings 11.

As shown in FIG. 3 and the like, the housing 10 includes holding portions 15 and 16 that hold mounting portions 81 and 82 on both left and right side surfaces. The mounting portions 81 and 82 are sheet metal components that are formed by, for example, pressing a plate-shaped metal. The mounting portions 81 and 82 are connected by soldering or the like to the board 90 (FIG. 6) on which the connector 1 is to be mounted, and fix the housing 10 to the board 90.

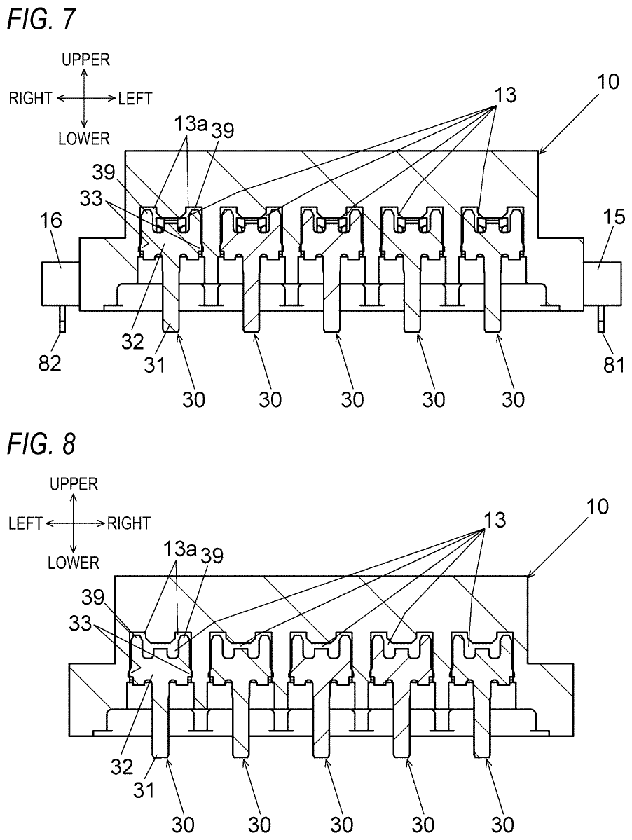

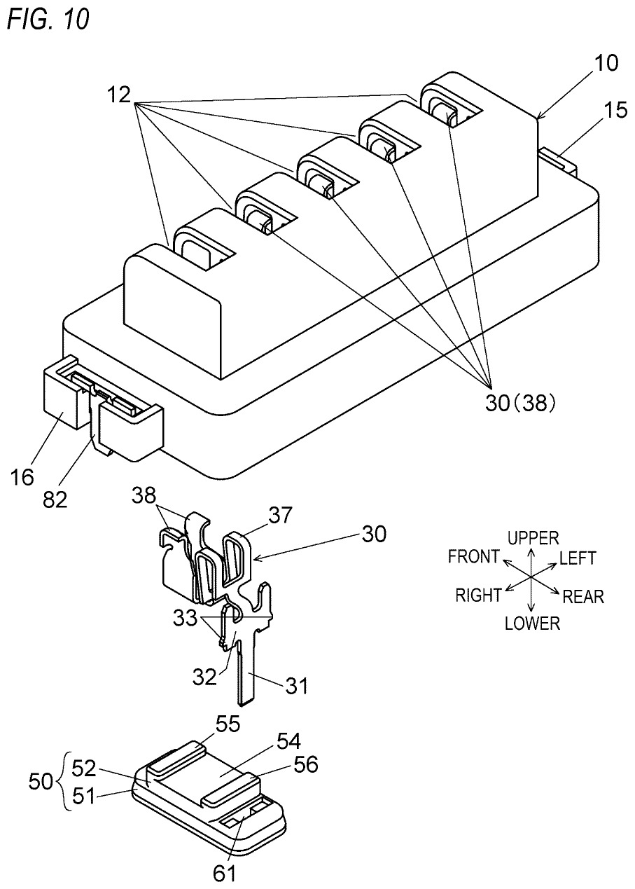

The terminal 30 is, for example, a sheet metal component that is formed by pressing a plate-shaped metal. The terminal 30 may be formed by molding or cutting. In the present embodiment, as shown in FIGS. 7 to 10, the terminal 30 includes a leg portion 31, the held portion 32, a plate spring portion 37, and a contact portion 38.

The leg portion 31 is a connection portion (a mounting portion) that is electrically connected by soldering or the like to a conductive pattern (not shown) on the board 90 (FIG. 6) on which the connector 1 is to be mounted. The leg portion 31 extends parallel to the upper-lower direction. The leg portion 31 penetrates the lid body 50 and the sealing material 70, and extends downward from the first opening 11 to the outside of the housing 10.

The held portion 32 is continuous with the upper portion of the leg portion 31. The held portion 32 is fitted into the holding hole 13 of the housing 10 and held in the holding hole 13. In the present embodiment, as shown in FIGS. 7, 8, and the like, the held portion 32 includes protrusions 33 at the left and right end portions of the held portion 32 and two angular portions 39 at the upper portion of the held portion 32. The protrusions 33 bite into the left and right inner surfaces of the holding hole 13 and generate a holding force for the holding hole 13. The angular portions 39 are fitted into the left and right grooves 13a of the holding hole 13 to improve the holding force. However, the holding structure is not limited to this form. Regarding the holding of the terminal 30 on the housing 10, adhesion may be used instead of or in addition to the holding force provided by the protrusions 33 and the angular portions 39.

The plate spring portion 37 has a substantially inverted U shape when viewed from the side, and is continuous with the upper portion of the held portion 32. The plate spring portion 37 acts to give the contact portion 38 appropriate flexibility. The contact portion 38 is supported on the plate spring portion 37, and is exposed to the outside of the housing 10 from the second opening 12. The contact portion 38 is divided into two parts on the left and right, between which a terminal (a plug) of a mating connector (not shown) is inserted and electrically connected.

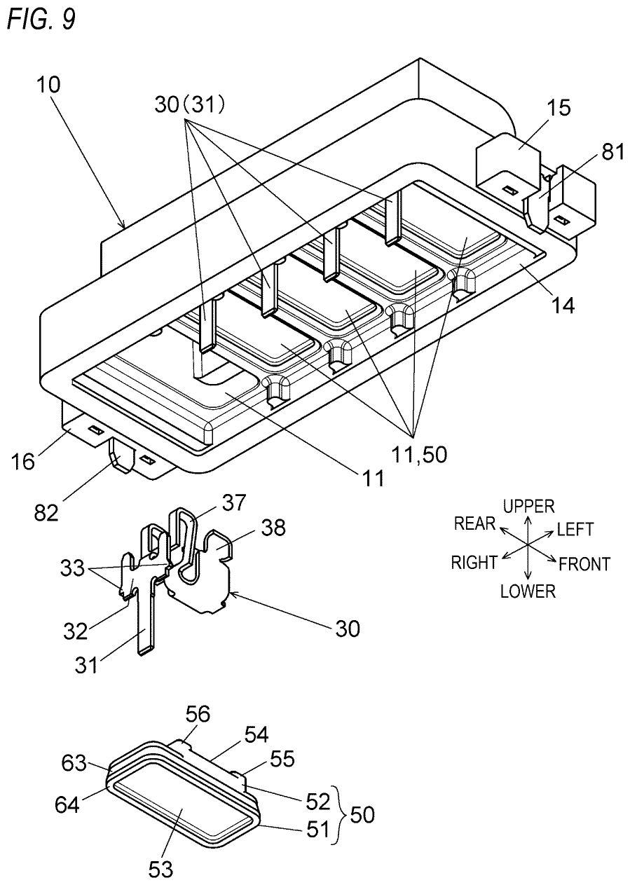

As shown in FIGS. 6 and 9, the lid body 50 closes the first opening 11. The lid body 50 is an elastic body such as silicone rubber, and the side peripheral portion (the side peripheral surface) thereof is pressed against the inner peripheral portion (the inner peripheral surface) of the first opening 11 by the own elastic force of the lid body 50, and is held in a state of closing the first opening 11.

As shown in FIGS. 6 and 9 to 12, the lid body 50 includes a first portion 51 and a second portion 52. The first portion 51 is a lower portion of the lid body 50 and is fitted into the first opening 11. The second portion 52 is the upper portion of the lid body 50 and protrudes upward from the upper surface of the first portion 51. The second portion 52 is smaller in dimension in the front-rear direction than the first portion 51. The second portion 52 protrudes from the first opening 11 into the space in the housing 10.

The lid body 50 includes an inclined portion 63 on the side peripheral portion of the first portion 51. The inclined portion 63 is an inclined surface that widens from above to below, and is provided around the entire side peripheral portion.

The lid body 50 includes a surrounding portion 64 that is continuous with the lower portion of the inclined portion 63. The surrounding portion 64 is a convex portion that is located at the outer peripheral portion of the lower surface of the lid body 50 and that extends in a substantially rectangular shape.

The lid body 50 has a recess 53 (a hollow portion) on the lower surface, that is, the surface facing the outside of the housing 10. The recess 53 is surrounded by the surrounding portion 64 on the front, rear, left and right sides.

The outer dimension of the surrounding portion 64 before being fitted into the first opening 11 is slightly larger than the inner dimension of the first opening 11. Accordingly, when the side peripheral portion of the surrounding portion 64 is fitted into the first opening 11, the side peripheral portion is pressed against the inner peripheral portion of the first opening 11 and elastically deforms, and generates a holding force for the first opening 11. At this time, the recess 53 is present, so that the surrounding portion 64 can elastically deform and escape into the recess 53, and the bending of the lid body 50 in the upper-lower direction is prevented.

The lid body 50 has a recess 54 on the upper surface, that is, the surface facing the inside of the housing 10. The lid body 50 includes protrusions 55 and 56 on the front and rear of the recess 54, respectively. The recess 54 prevents the lid body 50 from interfering with the terminal 30 or preventing elastic deformation of the terminal 30 when the lid body 50 is bent upward. The protrusions 55 and 56 prevent excessive deformation of the terminal 30.

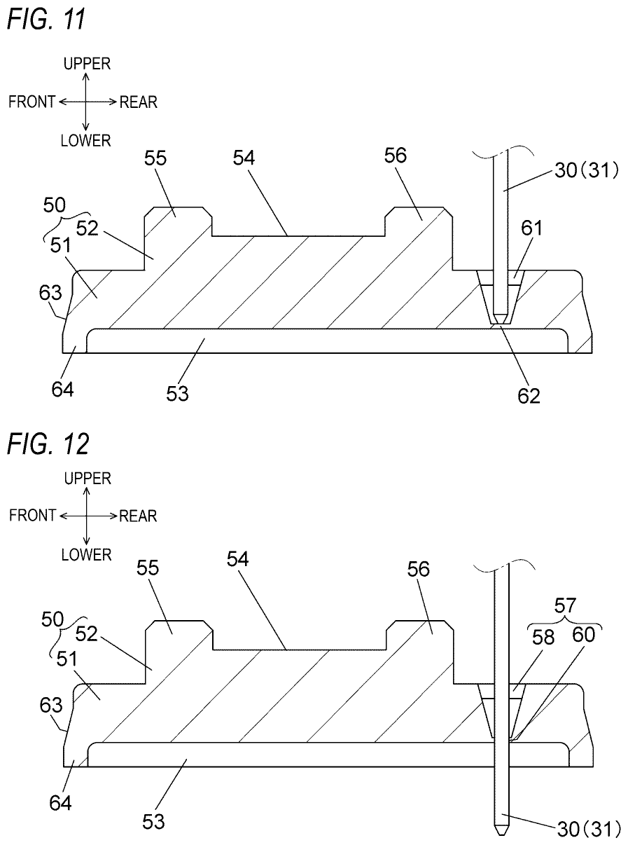

As shown in FIGS. 6 and 12, the lid body 50 has a through portion 57 in the first portion 51 through which the leg portion 31 of the terminal 30 passes. The inner surface of the through portion 57 is in elastic contact with the outer surface of the leg portion 31 at the lower end portion serving as a part in the upper-lower length direction, and the inner surface is not in contact with the outer surface of the leg portion 31 at the other part in the upper-lower length direction. That is, as shown in FIG. 12, the through portion 57 includes a contact portion 60 whose inner surface is in elastic contact with the outer surface of the leg portion 31, and a non-contact portion 58 whose inner surface is not in contact with the outer surface of the leg portion 31. The contact portion 60 is a portion that is formed by the leg portion 31 breaking through the bottom portion 62 of the bottomed hole 61 shown in FIG. 11. The non-contact portion 58 is inclined so as to widen as the non-contact portion 58 goes upward.

The sealing material 70 is a material such as urethane resin or epoxy resin, and covers the first opening 11 that is closed by the lid body 50 from the outside of the housing 10. The sealing material 70 fills the inside of each of the five first openings 11, and fills up to a depth that exceeds the first opening 11 and that touches the inner peripheral portion of the surrounding portion 14.

A method for manufacturing the connector 1 is as follows, for example.

The terminal 30 is inserted into the housing 10 through the first opening 11 of the housing 10, the contact portion 38 of the terminal 30 is exposed to the outside of the housing 10 through the second opening 12, and the leg portion 31 of the terminal 30 protrudes from the first opening 11. Subsequently, the lid body 50 having the bottomed hole 61 (FIG. 11) is assembled so as to close the first opening 11, and the leg portion 31 breaks through the bottom portion 62 of the bottomed hole 61. Subsequently, a potting process is performed. Specifically, the sealing material 70 fills the first opening 11 that is closed by the lid body 50 so as to cover the first opening 11 from the outside of the housing 10.

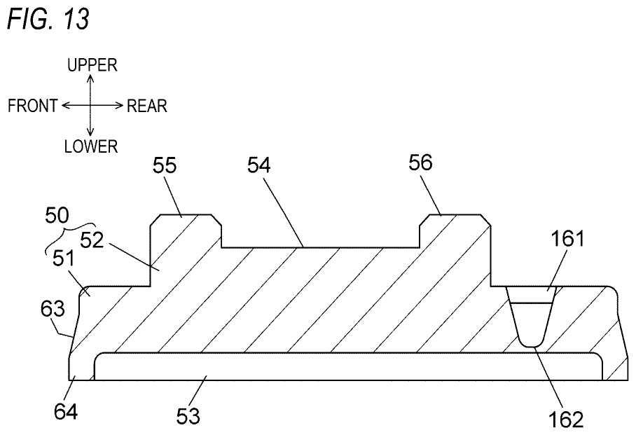

The bottomed hole 61 of the lid body 50 may be a bottomed hole 161 that has a curved shape having a predetermined curvature around the bottom portion 162 as shown in FIG. 13. By forming the curved shape, the leg portion 31 can be adjusted such that when the leg portion 31 penetrates, the leg portion 31 penetrates approximately at the center of the bottom portion 162, rather than at the boundary between the bottom portion 162 and the side surface. Since the leg portion 31 penetrates approximately at the center, the generation of burrs on the bottom portion 162 after penetration can be prevented.

The present embodiment has the following effects.
(1) Since the first opening 11 of the housing 10 is closed by the lid body 50 and further covered with the sealing material 70, the water that enters the housing 10 through the second opening 12 can be prevented from leaking out through the first opening 11 to the outside. Accordingly, even when the mating connector is not fitted to the connector 1, the waterproof property can be improved. In addition, the waterproof property can be ensured while securing the movable range of the mating connector.
(2) The leg portion 31 of the terminal 30 penetrates the lid body 50 and the sealing material 70, and extends downward from the first opening 11 to the outside of the housing 10. Therefore, as compared with a configuration in which the terminal 30 is pulled out around the lid body 50, for example, to the rear of the lid body 50, and then extended downward, the housing 10 can be made smaller and simpler in structure, and waterproofing of the pulled-out portion is not required.
(3) The lid body 50 is an elastic body, and is fitted into the first opening 11 by the own elastic force thereof and held in the first opening 11. Therefore, a configuration is not necessary in which the lid body 50 is pressed from below, and an increase in the number of components and cost can be prevented. In comparison, in the case of a configuration in which a sheet metal component that presses the lid body 50 from below is assembled to the housing 10, it is difficult to use a configuration in which the leg portion 31 of the terminal 30 penetrates the lid body 50. In the present embodiment, such a disadvantage can be eliminated.
(4) Since the lid body 50 is an elastic body, a gap between the side peripheral portion of the lid body 50 and the inner peripheral portion of the first opening 11 is less likely to be formed, and the filling range of the sealing material 70 is easily controlled. That is, it is possible to prevent the sealing material 70 from leaking out and adhering to the inside of the housing 10 during the potting process.
(5) Since the recess 53 is formed in the lower surface portion of the lid body 50, when the side peripheral portion of the surrounding portion 64 is pressed against the inner peripheral portion of the first opening 11 and is elastically deformed, the surrounding portion 64 can escape into the recess 53. Therefore, the bending of the lid body 50 in the upper-lower direction is prevented. Accordingly, it is possible to prevent the lid body 50 from bending downward and the filling range of the sealing material 70 from becoming narrow. It is possible to prevent the lid body 50 from bending upward and interfering with the terminal 30 or hindering elastic deformation of the terminal 30.
(6) Since the recess 54 is formed in the upper surface portion of the lid body 50, it is possible to prevent the lid body 50 from interfering with the terminal 30 or hindering elastic deformation of the terminal 30 when the lid body 50 is bent upward. On the other hand, since the lid body 50 includes the protrusions 55 and 56 at the front and rear of the recess 54 and the deformable amount of the terminal 30 is restricted by the protrusions 55 and 56, excessive deformation of the terminal 30 can be prevented.
(7) As shown in FIG. 12, the through portion 57 of the lid body 50 includes the contact portion 60 whose inner surface is in elastic contact with the outer surface of the leg portion 31, and the non-contact portion 58 whose inner surface is not in contact with the outer surface of the leg portion 31. The contact portion 60 is formed by the leg portion 31 breaking through the bottom portion 62 of the bottomed hole 61 shown in FIG. 11 when the connector 1 is assembled. Therefore, regardless of whether the leg portion 31 is rectangular as in the present embodiment or has any other shape, such as a thin plate or a round shape, the gap between the outer peripheral portion of the leg portion 31 and the contact portion 60 can be reduced, and the sealing material 70 can be prevented from leaking out and adhering to the inside of the housing 10 during the potting process. Since it is not necessary to design the bottomed hole 61 for each shape of the leg portion 31, the lid body 50 can be used for various terminals.
(8) Since the leg portion 31 of the terminal 30 breaks through the bottomed hole 61 of the lid body 50 at the time of assembling the connector 1, it is not necessary to form the through hole in the processing step of the lid body 50, and the productivity at the time of processing the lid body 50 is high. If the through hole is to be formed from the processing stage of the lid body 50, in the method for manufacturing the lid body 50 using a mold, the mold may be damaged due to the upper and lower molds applying pressure on each other at a portion where the upper mold and the lower mold of the mold form the through hole, or deterioration of the mold may be accelerated due to wear caused by repeated contact. On the other hand, in the present embodiment, since it is sufficient to form the bottomed hole 61 in the processing stage of the lid body 50, damage due to the pressure of the upper and lower molds and wear due to contact can be prevented.
(9) The inner dimension of the bottomed hole 61 is larger than the outer dimension of the leg portion 31 of the terminal 30. Therefore, the mold portion for forming the bottomed hole 61 may be larger than the outer dimension of the leg portion 31, and the strength and durability of the mold may be improved. For example, even in a method in which punching is performed as an additional process, if the through hole is to be formed in the lid body 50, it is necessary to form the inner dimension of the through hole to be smaller than the outer dimension of the leg portion 31 in order to ensure the waterproof property, and a precise processing technique is required. On the other hand, in the present embodiment, the inner dimension of the bottomed hole 61 is larger than the outer dimension of the leg portion 31 of the terminal 30. Therefore, even when punching is performed as the additional process, it does not require a precise processing technique as compared with the case of the through hole.
(10) Since the bottomed hole 61 is shaped to widen upward, the leg portion 31 of the terminal 30 can be easily inserted therein, and the assembling property is good. In the case of the bottomed hole 161 including the bottom portion 162 that has a curved shape as shown in FIG. 13, since the leg portion 31 can be adjusted so as to penetrate substantially the center of the bottom portion 162 at the time of penetration of the leg portion 31, the generation of burrs on the bottom portion 162 after penetration is prevented.

Embodiments and modifications of the present invention have been described above with reference to the drawings, but these embodiments and modifications are examples of the present invention, and various configurations other than those described above can also be used. For example, the number of the first openings 11 and the second openings 12 that are formed in the housing 10 and the number of the terminals 30 are not limited to five, and may be any number.

According to the present description, a connector and a method for manufacturing a connector according to the following aspects are provided.

### ASPECT 1

A connector including:
a housing having an opening;
a terminal accommodated in the housing;
a lid body closing the opening; and
a covering material covering, from an outside of the housing, the opening closed by the lid body,
in which the terminal penetrates the lid body and the covering material and extends toward the outside of the housing.

According to aspect 1, since the opening of the housing is closed by the lid body and further covered with the covering material, the waterproof property is improved.

### ASPECT 2

In the connector,
the housing has a second opening, and
the terminal is exposed to the outside of the housing through the second opening.

According to aspect 2, since the opening of the housing is closed by the lid body and further covered with the covering material, the water that enters the housing through the second opening can be prevented from leaking out through the opening to the outside. Accordingly, even when the mating connector is not fitted to the connector, the waterproof property can be improved. In addition, the waterproof property can be ensured while securing the movable range of the mating connector.

### ASPECT 3

In the connector,
the lid body is an elastic body, and a side peripheral portion of the lid body is pressed against an inner peripheral portion of the opening by an elastic force of the lid body.

According to aspect 3, a configuration is not necessary in which the lid body is pressed, and an increase in the number of components and cost can be prevented.

### ASPECT 4

In the connector,
the lid body has a recess on a surface that faces the outside of the housing.

According to aspect 4, the bending of the entire lid body can be prevented by the recess.

### ASPECT 5

In the connector,
the lid body has a recess on a surface that faces an inside of the housing.

According to aspect 5, interference between the lid body and the terminal can be prevented by the recess.

### ASPECT 6

In the connector,
the lid body is an elastic body, and has a through portion through which the terminal passes, and
an inner surface of the through portion is elastically in contact with an outer surface of the terminal at a portion thereof in a length direction of the through portion, and the inner surface is not in contact with the outer surface of the terminal at another portion thereof in the length direction.

According to aspect 6, unlike the case in which the inner surface of the through portion is in elastic contact with the outer surface of the terminal over the entire length direction, the productivity of the lid body is high and the assembling property is also improved.

### ASPECT 7

The connector further includes
a plurality of the terminals and a plurality of the lid bodies,
in which the housing has a plurality of the openings, and
in which the covering material covers the plurality of openings.

According to aspect 7, a plurality of terminals can be mounted on the housing. When the housing has a plurality of openings, since the plurality of openings are covered with a single covering material, the productivity is also improved as compared with a case in which each of the plurality of openings is covered individually.

### ASPECT 8

A method for manufacturing a connector, the method including:
inserting a terminal into a housing having a first opening and a second opening through the first opening of the housing, and placing the terminal in a state in which the terminal is exposed to an outside of the housing through the second opening and the terminal protrudes from the first opening;
assembling an elastic body having a bottomed hole to close the first opening, and causing the terminal to break through the bottomed hole; and
filling the first opening that is closed by the elastic body with a covering material to cover the first opening from the outside of the housing.

According to aspect 8, since it is not necessary to form a through hole at the processing stage of the elastic body, and it is sufficient to form a bottomed hole, the productivity of the elastic body is high. Since the portion of the elastic body where the terminal breaks through the bottomed hole is in elastic contact with the outer surface of the terminal, a gap is less likely to form, and leakage of the covering material can be prevented.

### ASPECT 9

In the connector,
a periphery of a bottom portion of the bottomed hole has a curved shape.

According to aspect 9, the generation of burrs on the bottom portion of the bottomed hole after the terminal penetrates is prevented.

### REFERENCE SIGNS LIST

1: connector
10: housing
11: first opening
12: second opening
30: terminal
50: lid body
53, 54: recess
57: through portion
58: non-contact portion
60: contact portion
61: bottomed hole
70: sealing material

1. A connector including:
a housing having an opening;
a terminal accommodated in the housing;
a lid body closing the opening; and
a covering material covering, from an outside of the housing, the opening closed by the lid body,
wherein the terminal penetrates the lid body and the covering material and extends toward the outside of the housing.

2. The connector according to claim 1,
wherein the housing has a second opening, and
wherein the terminal is exposed to the outside of the housing through the second opening.

3. The connector according to claim 1,
wherein the lid body is an elastic body, and a side peripheral portion of the lid body is pressed against an inner peripheral portion of the opening by an elastic force of the lid body.

4. The connector according to claim 3,
wherein the lid body has a recess on a surface that faces the outside of the housing.

5. The connector according to claim 3,
wherein the lid body has a recess on a surface that faces an inside of the housing.

6. The connector according to claim 1,
wherein the lid body is an elastic body, and has a through portion through which the terminal passes, and
wherein an inner surface of the through portion is elastically in contact with an outer surface of the terminal at a portion thereof in a length direction of thee through portion, and the inner surface is not in contact with the outer surface of the terminal at another portion thereof in the length direction.

7. A connector, including
a housing having a plurality of openings;
a plurality of terminals accommodated in the housing;
a plurality of lid bodies closing the openings; and
a covering material covering, from an outside of the housing, the openings closed by the lid bodies,
wherein the terminals respectively penetrate the lid bodies and the covering material and extend toward the outside of the housing.

8. A method for manufacturing a connector, the method including:
inserting a terminal into a housing having a first opening and a second opening through the first opening of the housing, and placing the terminal in a state in which the terminal is exposed to an outside of the housing through the second opening and the terminal protrudes from the first opening;
assembling an elastic body having a bottomed hole to close the first opening, and causing the terminal to break through the bottomed hole; and
filling the first opening that is closed by the elastic body with a covering material to cover the first opening from the outside of the housing.

9. The method for manufacturing a connector according to claim 8,
wherein a periphery of a bottom portion of the bottomed hole has a curved shape.
